(19) United States
(12) Patent Application Publication
(10) Pub. No.: US 2012/0253949 A1
(43) Pub. Date: Oct. 4, 2012

(54) Creative Single-Layer Advertising Method

(75) Inventor: Ahmad Ammar, Los Angeles, CA (US)

(73) Assignee: Ahmad Ammar, Los Angeles, CA (US)

(21) Appl. No.: 13/354,073

(22) Filed: Apr. 3, 2012

Related U.S. Application Data
(60) Provisional application No. 61/435,353, filed on Jan. 24, 2011.

(51) Int. Cl. G06Q 30/02

(52) U.S. Cl. 705/14.72

(57) ABSTRACT

An advertising method that increases the effectiveness of a Single Display Layer promotion, and strengthens its impact on recipients, by combing the contents of the business promotion with entertainment & useful information. This combination is printed, painted or digitally placed on a ONE SINGLE DISPLAY LAYER (paper, carton, card, board, screen, spotlight etc.).

### FIELD OF INVENTION

A method of Advertising

### BACKGROUND OF THE INVENTION

A. Observation of an Unsolved Existing Problem:

While the inventor was working in the distribution of promotional flyers, he noticed:
1. The first reaction of most flyer recipients was to discard them without looking at them.
2. The frustrations of business owners over the ineffectiveness and uselessness of flyers, the one and only advertising method they could afford.
3. Urban streets littered with discarded advertising flyers.

B. The Problem Vs the Solution:

| Identifying the Single-Display Layer | |
|---|---|
| Advertising Method as a Problem | Identifying C Flyer as a solution |
| An ineffective advertising | An effective advertising tool |
| tool with a high failure | that increases prospective |
| rate to increase prospective | customer awareness to a |
| customer awareness | business or product without |
| to a business or product | increased costs over regular |
| that is often a waste of | Single-Display Layer |
| finances for a business | Advertising Method. |
| Has little or no appeal to | Appeals to its targeted receiver |
| its targeted receiver and | with free interactive entertainment |
| does not distinguish | and informative materials, which |
| itself from other promotions. | distinguishes it from Promotions |
| As an advertising tool, it is a waste of | As an advertising tool, it is not an |
| natural resources and promotional | unnecessary waste of natural |
| dollars as it is often unread, | resources or promotional dollars |
| immediately discarded and does | as it has the potential to be |
| not fulfill its purpose; to draw | saved and shared with others and |
| attention to its subject of | thereby fulfills its purpose; to draw |
| promotion. | attention to its subject of promotion. |

C. Distinguishing Features of C Flyer
1—The first and only Single-Display Layer Advertising Method that combines a Creative Product with a Business Promotion, while retaining all their separate characteristics, features and functions, to produce a new advertising product.
2—New and not based on any prior product.
3—Useful:
   a. Helps small and medium businesses grow and flourish within their local markets with a unique, high quality advertising product that is effective and affordable for any budget.
   b. Provides an alternative to regular Single-Display Layer Advertising Method that is statistically ineffective, wasteful and seldom read.
   c. Provides valuable free materials to its recipients to read and interact with that will result in longer exposure to the subject of promotion.
   d. Opens new opportunities for creative writers and artists.
4—Not obvious: Despite the fact Single-Display Layer Advertising Method have been in use for generations, no similar method to C Flyer has been used as an actual advertising tool.
5—Producible: C Flyer is an Advertising Method related to a work cycle of writing, creative artwork, graphic design, computer work and printing to produce an actual advertising product.
6—Needful: Provides a unique impact on its recipients with an affordable, interactive advertising product that helps attract and retain customers by standing out and distinguishing the subject of promotion from all other promotions in a manner previously unavailable.

### BRIEF SUMMARY OF THE INVENTION

Noticeably, Single Display Layer advertising products, (such as flyers, postcards, door hangers, billboards, advertising bulk email and mobile phone messages, vehicle ads, etc) are unread and discarded because of their little or no appeal to their targeted receivers. This fact results a high failure rate to increase prospective customers' awareness to a business or product.

To solve such an unsolved problem and disadvantage, the Creative Singly Display Layer adds a portion of entertaining and useful materials (such as illustrated stories, puzzles, articles, digital games, animation, etc.) to the contents of the Business Promotion. This new addition strengthens the impact on recipients and turns Single Display Layer advertising product into an effective advertising tool that fulfills its purpose; to draw attention to its subject of promotion.

### DESCRIPTION OF THE SEVERAL VIEWS OF THE DRAWING WITH DETENTIONS OF TERMS

### A—Description of the Several Views of the Drawing

### “Side-by-Side” Combination

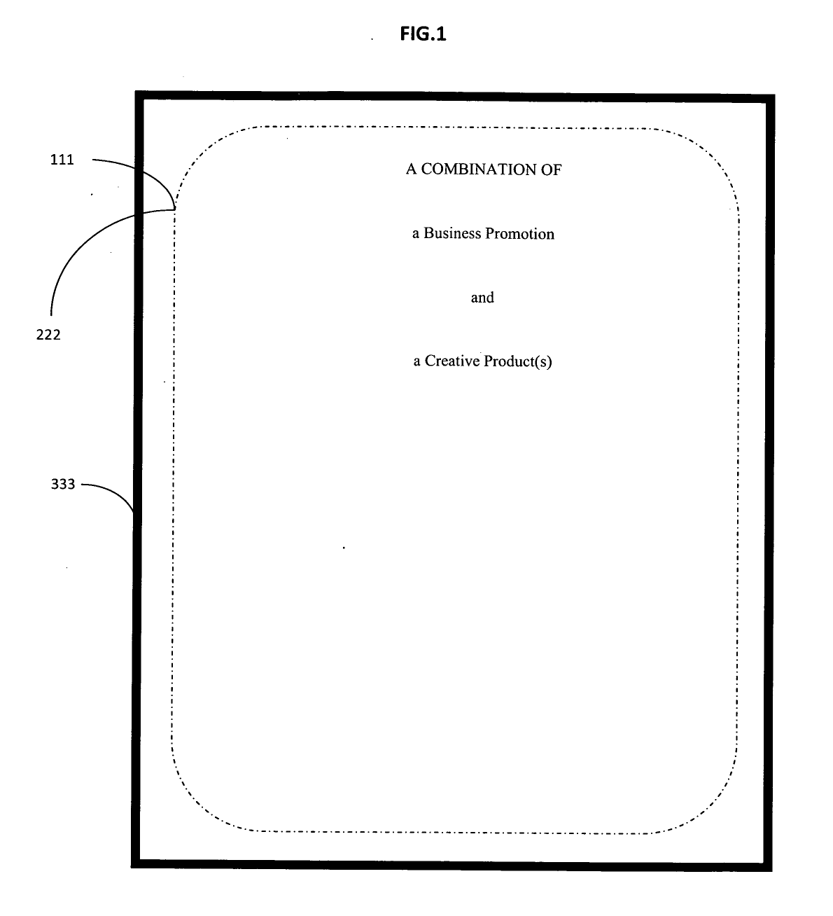

FIG. 1 shows the combination of a Business Promotion (#111) with Creative Product(s) (#222) together side-by-side on the same side of a Single Display Layer (#333)

### “Back-to-Back” Combination

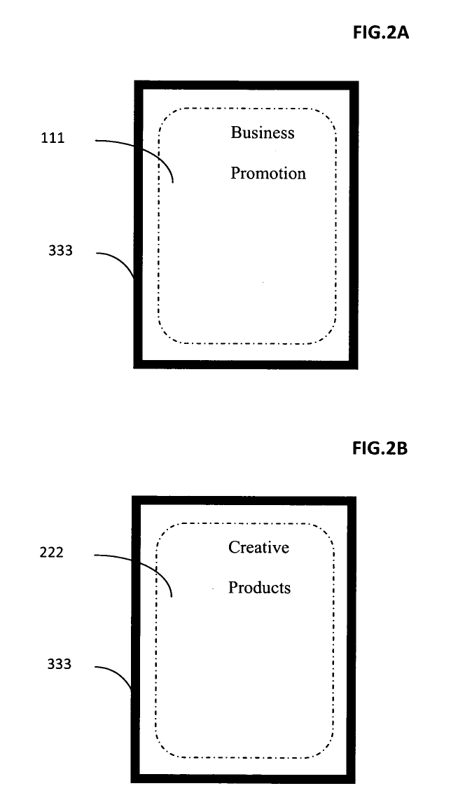

FIG. 2A shows the method layout, wherein a Business Promotion (#111) is displayed on one side of a Single Display Layer (#333).

FIG. 2B shows the method layout, wherein a Creative Product(s) (#222) is displayed on the opposite side of a Single Display Layer (#333).

Note: The Single Display Layer (#333) of FIG. 2A and FIG. 2B is the same. Each is displayed on one side of it (#333).

### “Attached Layers”

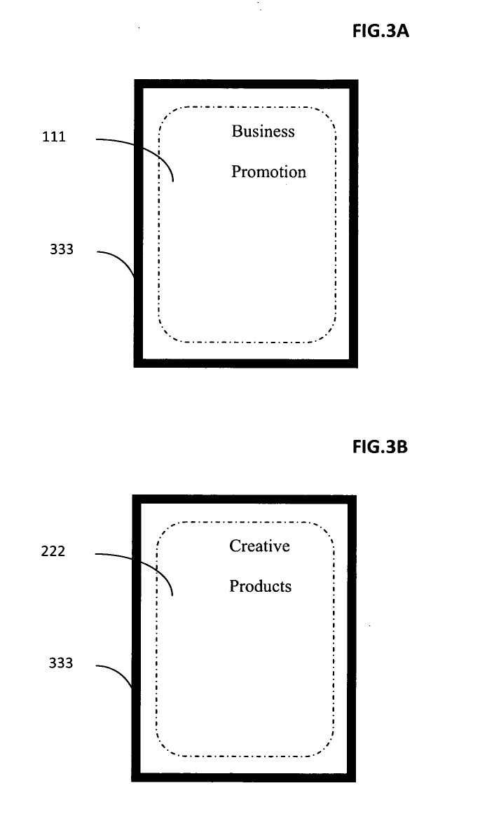

FIG. 3A shows the method layout, wherein a Business Promotion (#111) is displayed on one Single Display Layer (#333).

FIG. 3B shows the method layout, wherein a Creative Product(s) (#222) is displayed on another Single Display Layer (#333).

Note: The Single Display Layers (#333) of FIG. 2A and FIG. 2B is completely separate, but the recipient receives both of them together within the same delivery.

### B—DEFINITIONS OF TERMS

1—Business Promotion herein refers to the information that are made available to the public to generate a positive and profitable awareness of the prompted business such as a logo, contact information (email address, phone #, fax #, physical address), a service or product desecration, offers, discounts, etc. See (#111) on all FIGS.
2—Creative Product(s) herein refers to a creative, entertaining & interactive material (such as a puzzle, an article, a challenging question, an illustrated story, a multimedia work, an animation or an interactive game, etc. . . . ), which is either:
   General and unrelated to the promoted service or product and does not promote its own interest(s), name, feature(s) or anything related to it individually
   Or customized at client's request for an extra fee. See (#222) on all FIGs.
3—Single Display Layer: herein refers to any flat platform that has only one side such as screens and spotlights, or double sides, which Client may request shaping (folding, bending, rolling, etc.), but the original Promotion is limited to a maximum of two sides, the front and back, such as paper, fabric, plastic, etc. See (#333) on all FIGS.
4—Single-Display Layer Advertising Method (Prior Art) herein refers to advertising products such as flyers, door hangers, postcards, billboards, exterior vehicle ads, store receipt ads, signage, bulk email, email newsletters, mobile phones text & multimedia messages and other similar products that are considered by the average person to belong in the same category and with the following characteristics:
a. Made to advertise and promote: The sole purpose of production is to advertise and promote. Otherwise they lose their function or serve as other forms of non-advertising production.
b. Primarily dedicated to advertising and promoting ONE subject (business, product, service or cause) per Promotion unless the client requests otherwise.
c. Displayed on said Single Display Layer. See (#333) on all FIGs.
d. Client approval required: The promotion design; contents; size; type of material; quantity; and area(s) and avenue(s) of distribution for the ENTIRE promotion is selected, proofed and approved by the client, not the producer, manufacturer or advertising company, before production begins.
e. Delivery to the intended recipient is not conditioned upon the purchase of a SPECIFIC service or product.

### DETAILED DESCRIPTION OF THE INVENTION

A—Production Process:

1—Pre-Start:
Writers create scripts and texts for articles, illustrated stories, puzzles, etc.
Artists, graphic designers or animators add artwork to the scripts and texts to complete the final Creative Product.

2—Submission of Job Order and Data:
A client submits an existing promotional file(s) (via interne upload, postal delivery or in person) and a completed order form that includes campaign instructions and objectives (targeted age, gender and zip code(s), etc.), campaign aspects and type of Creative Product.

3—Pre-Production:
According to the client's instructions, a graphic designer combines the client's existing promotional file(s) with the requested Creative Product(s) to make the completed C Flyer layout.
If requested, the Creative Product is customized to fit in the promotion contents.
A completed design proof is made available for the client's approval.

4—Production:
Upon the client's approval of a proof, the C Flyer layout is sent to production begins.

5—Distribution:
Once production has been completed, the client's C Flyer is ready for delivery or distribution according to the client's instructions.

B—Methods of Distribution:
1Direct mail
2—Hand-to-car
3—Hand-to-door
4—Hand-to-hand
5—Street stands
6—Onsite
7—Newspaper and magazine inserts
8—Billboards (Printed and Digital Screen Form)
9—Signage
10—Receipts
11—Email Blast
12—Email Newsletter
13—Mobile phones text & multimedia messages

C. Categories Based on Creative Product Contents

Five creative C Flyer categories cover a wide, varied range of interests:
1—C Comic—Flyer: Episodic illustrated stories with unique characters in a variety of genres will attract readers and make them more aware of the subject of promotion.
2—C Puzzle—Flyer: A variety of fun and challenging puzzles that will keep the prospective customer's eye on the subject of promotion much longer than average.
3—C Useful Article—Flyer: Provides brief interesting and useful articles on health, diet, nutrition, sports, history, art and entertainment that will draw attention to the subject of promotion.
4—C Multimedia Flyer: Provides digital entertaining and useful contents such as a computer game, animation, informative form or test, etc. . . . .
5—C Read & Win—Flyer: A question is included in the Creative Product that the reader must answer correctly (via the business e-mail, website or location) in order to receive a prize or special offer from the promoting business.
   “This Read & Win—Flyer” option is perfect to:
Increase traffic to a business website
Increase walk-ins or notify customers of a business location
Build a database of customers and potential customers
Track and analyze the effectiveness of various promotional campaigns

D. Displaying Formats of C Flyer:
1-Mixed: the client's Promotion and the Creative Product are displayed on the same Single-Display Layer either “side-by-side” on one side. See FIG. 1, or “back-to-back” (one on the front side, the other on the backside) See FIGS. 2A and 2B.
2-Attached Layers: The client's promotion and the Creative Product are placed on separate Single-Layer Printed Promotions and are then attached to each other to be received in one delivery. See FIGS. 3A and 3B.

E. Applications for the Market:

C Flyer Leaf (aka C Leaf): includes flyers, door hangers, postcards, display cards and boards etc.
C Flyer Billboards (aka C Billboards): includes exterior vehicle ads and display screens.

### C Flyer Receipts (aka C Receipts)

C Flyer Message: includes email blast, email newsletter and mobile device texts and multimedia messages.

I claim:

1. A method for advertising, comprising the steps of:
a) creating and designing the contents of said Business Promotion and said Creative Product(s).
b) displaying the said Contents on a Single Display Layer. See all FIGs.

2. The Single Display Layer of claim 1 is a leaf such as a flyer, a door hanger, a postcard etc.

3. The Single Display Layer of claim 1 is a store receipt or invoice.

4. The Single Display Layer of claim 1 is a public Display Layer such as a screen, a sign, a billboard, a vehicle ad, a spotlight etc.

5. The Single Display Layer of claim 1 is made of wood.

6. The Single Display Layer of claim 1 is made of glass.

7. The Single Display Layer of claim 1 is made of plastic.

8. The Single Display Layer of claim 1 is made of metal.

9. The Single Display Layer of claim 1 is made of fabric.

10. The Single Display Layer of claim 1 is made of rubber.

11. The Single Display Layer of claim 1 is made of leather.

12. The Single Display Layer of claim 2 is the body of an advertising bulk email message.

13. The contents of claim 1 are displayed together side-by-side on the same side of the Single Display Layer. See FIG. 1

14. The contents of claim 1 are displayed back-to-back, one side for said Business Promotion and the other side for said Creative Product(s). See FIGS. 2A and 2B

15. The contents of claim 1 are displayed as attached layers, one Single Display Layer for said Business Promotion and another Single Display Layer for said Creative Product(s), and the recipient obtains both of them within the same delivery. See FIGS. 3A and 3B.

16. The method of claim 15 displays said Business Promotion on the body of an advertising bulk email message, and includes the content file of said Creative Product(s) as an email attachment.

17. The method of claim 15 displays said Creative Product(s) on the body of an advertising bulk email message, and includes the content file of said Business Promotion (s) as an email attachment.

18. The method of claim 15 displays said Business Promotion on the body of an advertising bulk email message, which includes a referral URL link to the content file of said Creative Product(s) to it.

19. The method of claim 15 displays said Creative Product(s) on the body of an advertising bulk email message, which includes a referral URL link to the content file of said Business Promotion to it.
